(19) United States
(12) Patent Application Publication
(10) Pub. No.: US 2004/0207309 A1
(43) Pub. Date: Oct. 21, 2004

(54) Flat color display device and method of manufacturing

(76) Inventor: Dumitru Nicolae Lesenco, Austin, TX (US)

Correspondence Address: Dumitru N. LESENCO, 5800 John Blocker Court, Austin, TX, 78749, US

(21) Appl. No.: 10/418,827

(22) Filed: Apr. 21, 2003

(51) Int. Cl. H01J 1/62; H01J 63/04

(52) U.S. Cl. 313/495

(57) ABSTRACT

A flat color display device with carbon thin-film cold cathode field emission is provided for display of information by response to an electron beam of a phosphor coating on a face plate. A color display device is assembled from monolithic display sections on multilayer printed wiring board as active matrix. There is not restriction for maximum display sections number in the horizontal and vertical directions. Each monolithic display section is represented as ball grid array system on a package and is assembled from four separate fabricated parts: bottom support part, control chip, cathode-grid silicon part and anode top part. The interconnect between bottom plate, control chip, cathodes, modulating grid, x-y focusing grids, x-y deflecting grids and anode are implemented throw anisotropic etched and insulated holes in silicon cathode-grid part and interlayer vias. A silicon cathode-grid part includes on one side the multilayer interconnect ball grid array system for surface mount of control chip and bottom support plate using flip-chip bonding technology. Using silicon processing for the very large scheme integrated technology on another side of cathode-grid part are implemented the carbon thin-film cold cathode matrix with nanobels placed in situ, modulation grid matrix, x-y focusing grid matrix, x-y deflection matrix and top interconnect ball grid array system for surface mount of anode top part using flip-chip bonding technology to. The modulating grids that form the data columns then control the intensity (on or off) of each of the beams formed in the row, similar to cathode ray tube addressing. After that row is written, then the next row of sources is activated. Restring is performed row by row. A support part, control chip, cathode-grid part and anode part provides a vacuum tight envelope housing as monolithic structure. The display is operated at low voltages, down to 15 V. The results are high resolution, high brightness and low power requirements. The number of lead wires pulled out of the display is reduced dramatically.

### BACGROUND OF THE INVENTION

1. Field of the Invention

The present invention relates to an electron-emitting device, a cold cathode field emission device and a method for the production thereof, and it also relates to a cold cathode field emission flat color display and a method for the production thereof.

2. Description of the Related Art

Display manufactures continue to increase the pixel count in new display prototypes to meet consumer demand for higher information content and resolution. Addressing the pixels and color sub-pixels individually for such high pixel count displays requires the use of a large number of row and column drivers. There must be one row driver and one column driver for every row and column. The high driver count sets a limit on the economics of the display. The ideal FED would be a thin plate or panel on which there would appear such information as is designated by input digital or analog input signals.

One approach to the problem is represented by a system described in (1). Applied Nanotech, Inc. demonstrated a 3.5 inch diagonal device (called HyFED) combined the advantage of the carbon thin-film cold cathode FED with the electron optics of a cathode ray tube (CRT). The device has a total of 405 electron guns, each beam scanning a screen area of 6×8 dots. The dot pitch is 0.45 mm. The number of drivers required for the HyFED are about a factor of 50 less than required for a comparable FED. But the screen voltage in this case was 5 kV and Grid Assembly thickness is about 3 mm.

Active Matrix (CLVFD) Chip lighting vacuum fluorescent display, developed by Noritake, feature a bland of semiconductor and conventional vacuum fluorescent display (VFD) technologies. The result is a small graphics display with extremely high brightness, high resolution and power requirements. For 16×16 dot phosphor matrix on top of a 5.4×6 mm semiconductor chip that integrates memory functions and display driver circuits. These chips, arranged in a single-or double-stage format, make possible highly precise graphic displays. New technology has given these displays the additional benefits of low voltage (12 to 18V), high brightness (3500 cd/cm2 when Vdd2=15V), long life (20,000 hours) and low noise. There is no restriction in the horizontal direction for active matrix building, but the maximum chip number in the vertical direction is 2.

### SUMMARY OF THE INVENTION

In contrast to prior systems, the present invention is taking off the restrictions regarding the maximum display sections in horizontal and vertical directions, minimize the anode-cathode thickness and screen voltage value.

Provided is a flat color display device assembled from rectangle monolithic display sections on multilayer printed wiring board as active matrix. There is not restriction for maximum display sections number in the horizontal or vertical directions. Each monolithic display section is represented as ball grid array (BGA) system on a package and is assembled from four separate fabricated parts: bottom support part, control chip, cathode-grid silicon part and anode top part.

The interconnect between bottom plate, control chip, cathodes, modulating grid, x-y focusing grids, x-y deflecting grids and anode are implemented throw anisotropic etched and insulated holes in silicon cathode-grid part and interlayer vias.

A silicon cathode-grid part includes on one side the multilayer interconnect BGA system for surface mount of control chip and bottom support plate using flip-chip bonding (FCB) technology.

Using silicon processing for the VLSI technology on another side of cathode-grid part are implemented the carbon thin-film cold cathode matrix, modulation grid matrix, x-y focusing grid matrix, x-y deflection matrix and top interconnect BGA system for surface mount of anode top part using FCB technology to.

The modulating grids that form the data columns then control the intensity (on or off) of each of the beams formed in the row, similar to cathode ray tube addressing. After that row is written, then the next row of sources is activated. Restring is performed row by row. Because each soured addresses multiple pixels, the driver count is significantly reduced.

A support part, control chip, cathode-grid part and anode part provides a vacuum tight envelope housing as monolithic structure.

The display is operated at low voltages, down to 15 V. The results are high resolution, high brightness and low power requirements. The number of lead wires pulled out of the display is reduced dramatically.

### BRIEF DESCRIPTION OF THE DRAWINGS

The above objectives and advantages of the present invention will become more apparent by describing in detail a preferred embodiment thereof with reference to the attached drawings in which:

FIG. 1 is a crossection view of an embodiment of the invention

FIG. 2 is a face of multilayer PWB 25 for matrix of 6×8 monolithic color display sections.

FIG. 3 is a top view of anode part 23 for 40,000 pixels on 45×45 mm, control chip 21 and bottom support part 22. The control chip integrated CPU, memory functions and display driver circuits. Bottom support part is a regular area array package such as pin grid array (PGA) 45×45 mm with 180 pins.

FIG. 4 is a view of assembler parts of monolithic display section.

FIG. 5 is a crossection of a monolithic display section.

FIG. 6 is a view of a portion of the cathode-grid part for one pixel size 0.225×0.225 mm.

FIGS. 7 through 15 are diagrams for illustrating the process of manufacturing of cathode-grid part.

### DESCRIPTION OF THE PREFERED EMBODIMENTS

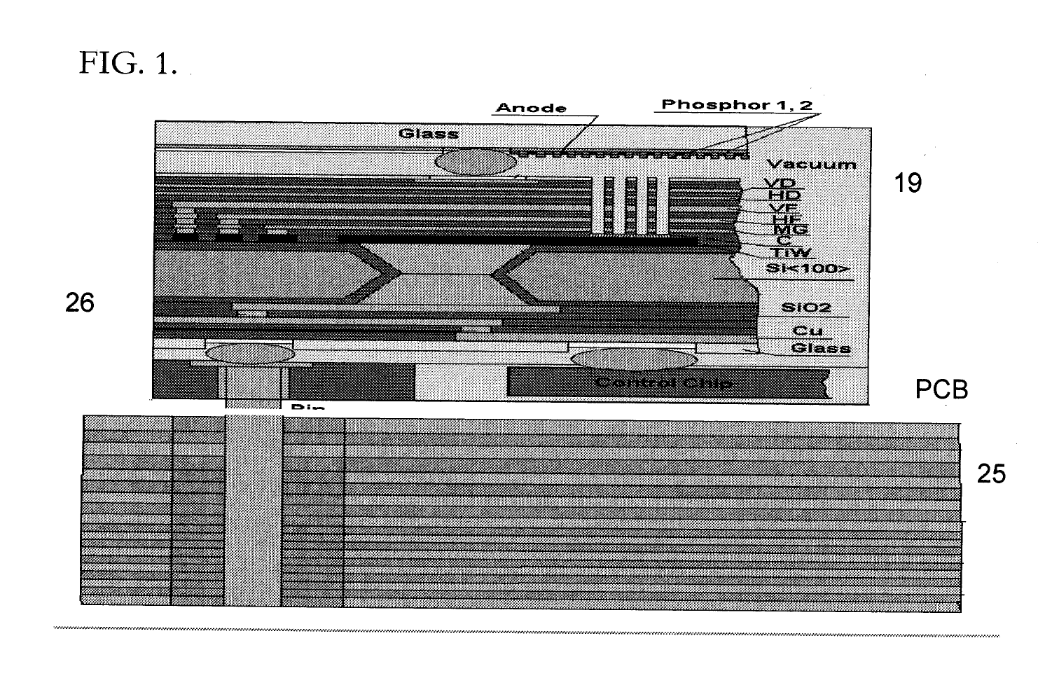

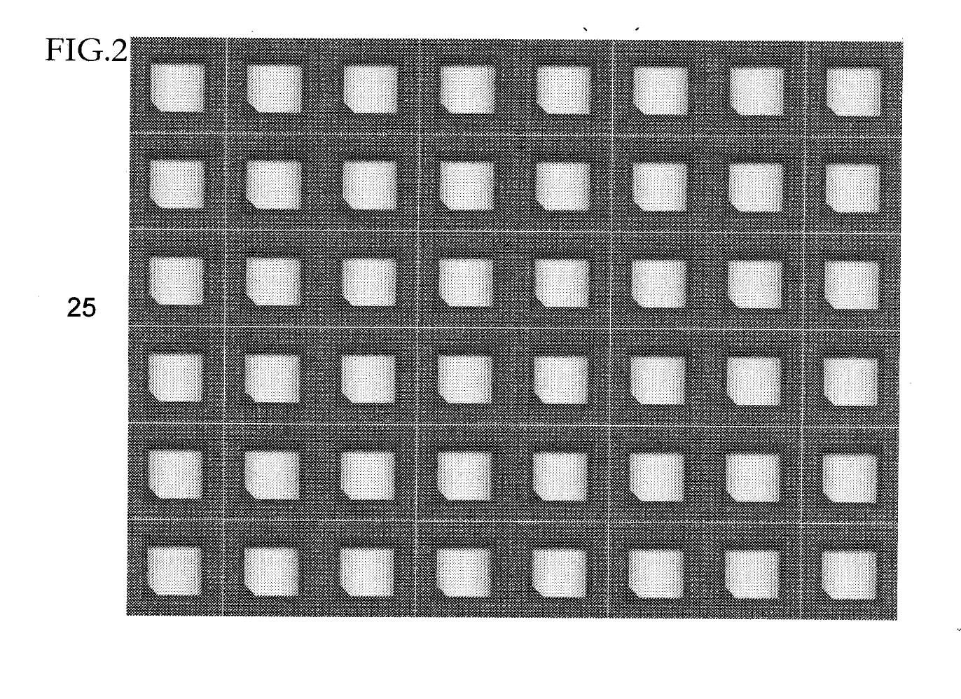

Referring to FIG. 1, a flat color display device according to a first embodiment of the present invention includes a flat panel color display section 19 assembled on multilayer PWB 25.

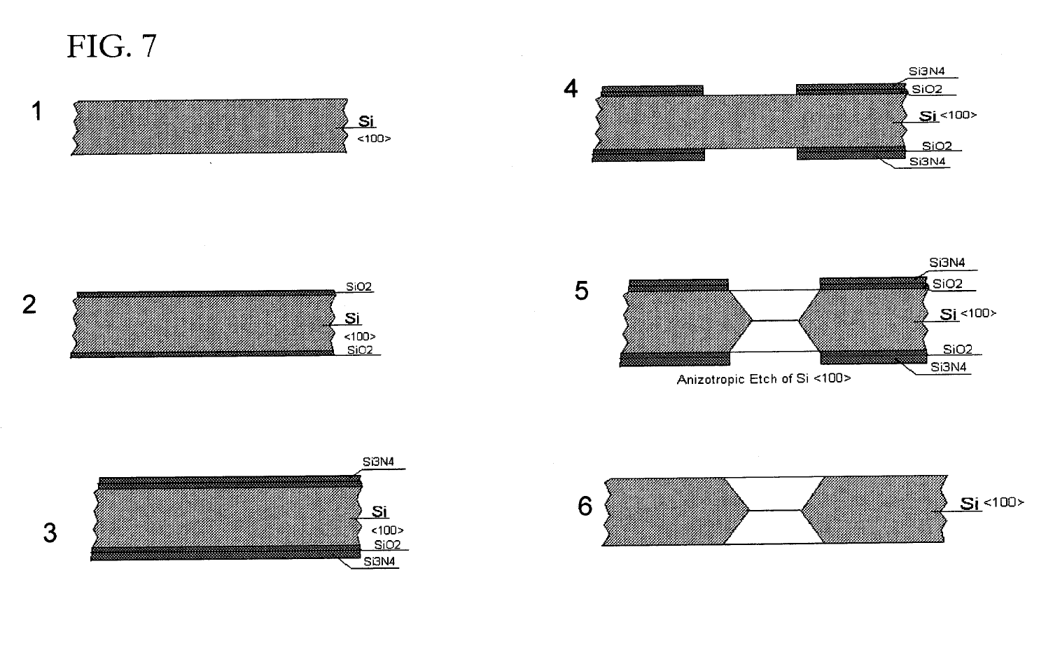

FIG. 7 illustrates the crossection for different stages of cathode-grid part fabrication:

1. Preparation of silicon wafer <100>.

2. Thermal oxidation of both sides of silicon wafer.

3. Deposition of nitride on both sides.

4. Photolithography and selective wet etching of nitride and silicon oxide on both sides.

5. Anisotropic etching of silicon.

6. Removal of nitride and silicon oxide.

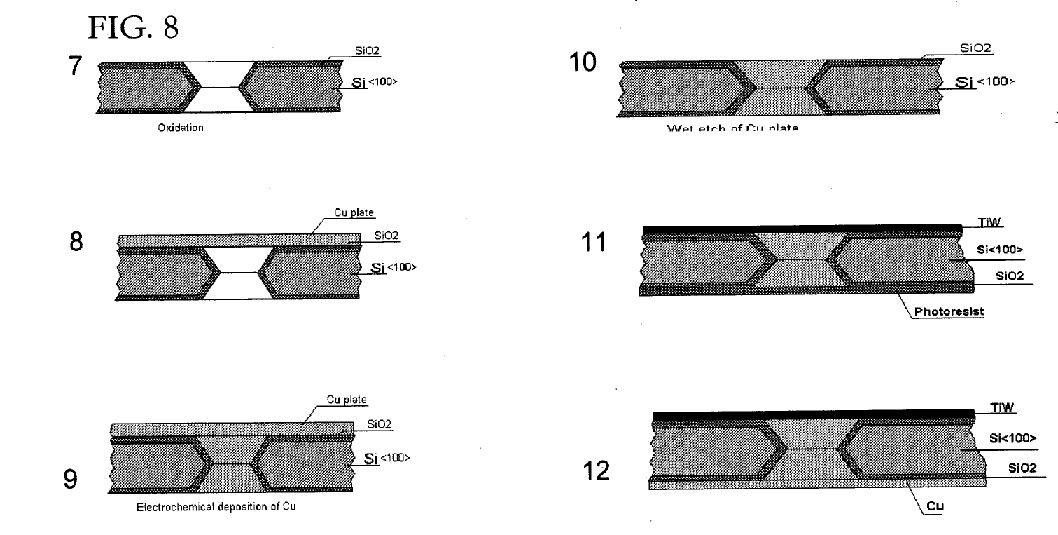

FIG. 8 illustrates the next stages of cathodes-grid part fabrication from FIG. 7:

7. Thermal oxidation of silicon wafer.

8. Installation of cupper plate on one side of silicon wafer as cathode.

9. Electrochemical deposition of copper into anisotropic etched and insulated holes.

10. Wet etching of copper plate and chemical mechanical polishing.

11. Conservation of one side and deposition of Titan-Tungsten film on another side of silicon wafer.

12. Deposition of copper film on another side of silicon wafer.

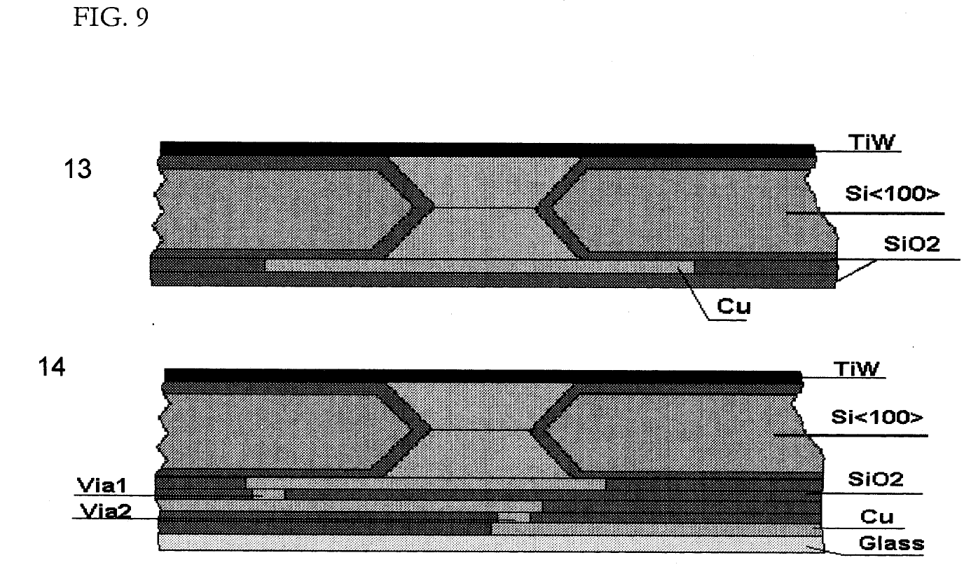

FIG. 9 illustrates the next stages of cathode-grid part fabrication from FIG. 8:

13. Photolithography of copper film and deposition of silicon oxide.

14. Photolithography for Via1, deposition of copper, photolithography of copper, deposition of silicon oxide, photolithography of Via2, deposition of copper and deposition of glass conservation film.

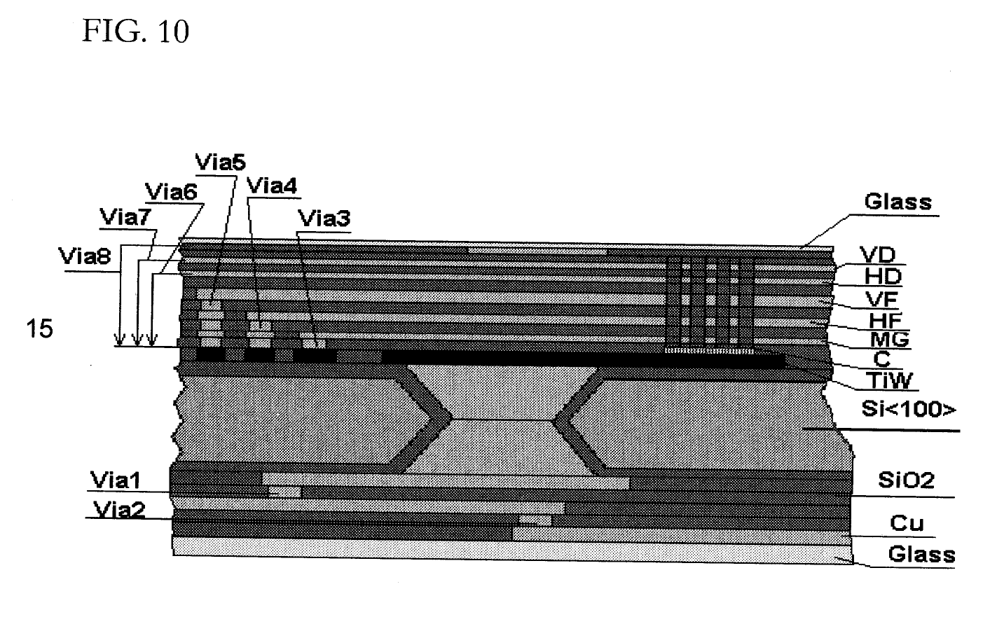

FIG. 10 illustrates the next stage of cathode-grid part fabrication from FIG. 9:

15. Electrochemical deposition of nickel on titan-tangsten film, photolithography of Ni—TiW film, deposition of silicon oxide, photolithography of Via3, deposition of second TiW film, photolithography of TiW for modulation grid MG, etching the silicon oxide films and opening of cathode windows throw first Ni—TiW film, chemical vapor deposition of carbon nanotubes and field orientation of nanotubes as nanobels using the negative potential of modulating grid during the chemical vapor deposition of carbon, deposition of silicon oxide, photolithography of Via4, deposition of copper, photolithography of copper for horizontal focusing HF, deposition of silicon oxide, photolithography of Via5, deposition of copper, photolithography of copper for vertical focusing VF, deposition of silicon oxide, photolithography of Via6, deposition of copper, photolithography of copper for horizontal deflection HD, deposition of silicon oxide, photolithography of Via7, deposition of copper, photolithography of copper for vertical deflection VD, deposition of silicon oxide, photolithography of Via8, deposition of cupper, photolithography of copper for anode interconnect, deposition of glass.

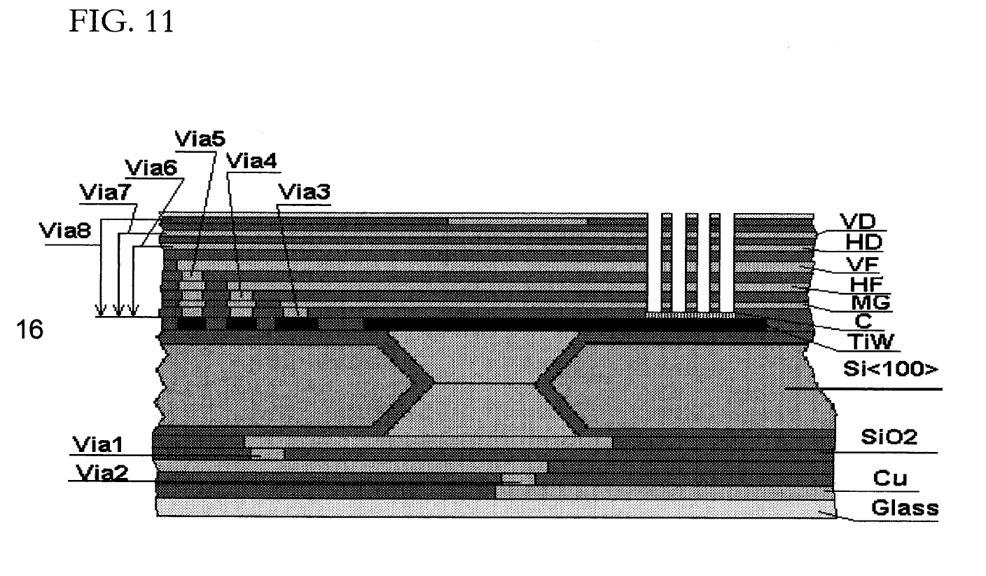

FIG. 11 illustrates the next stage of cathode-grid part fabrication from FIG. 10:

16. Photolithography of top glass film and opening of cathodes window throw nanobels.

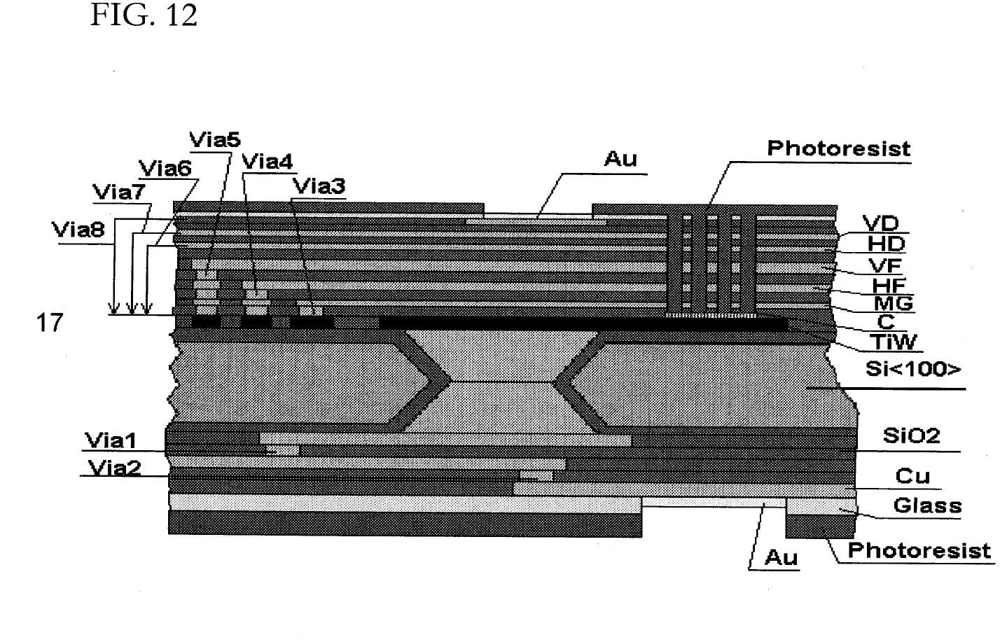

FIG. 12 illustrates the next stage of cathode-grid part fabrication from FIG. 11:

17. Deposition of photoresit on both side of silicon wafer, opening the windows on both sides of silicon wafer for BGA, deposition of golden film, deposition of photoresit on both sides of silicon wafer, photolithography of scribe lines, scribering.

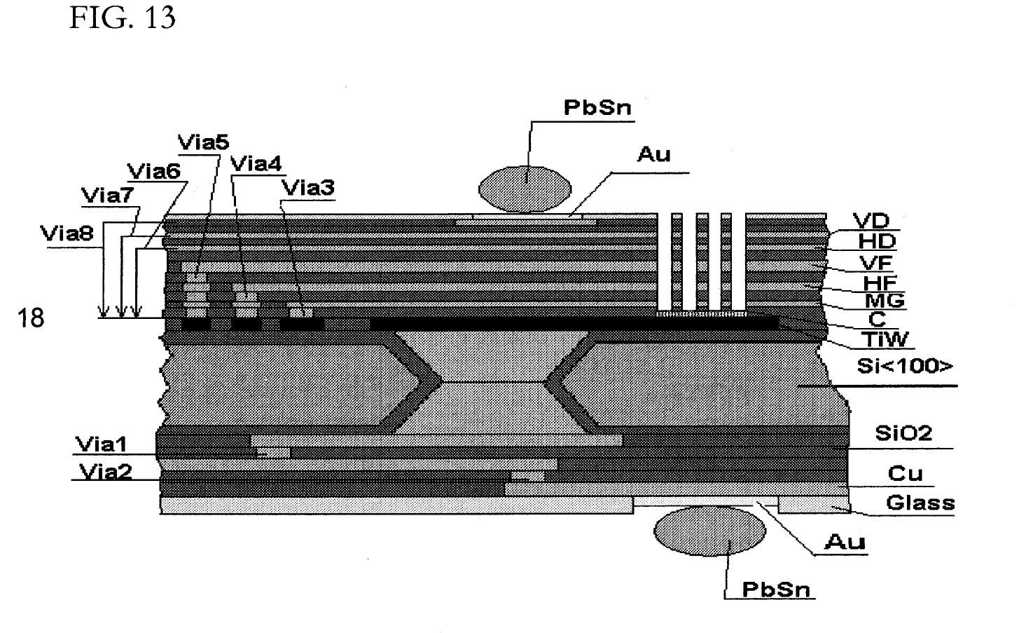

FIG. 13. illustrates the next stage of cathode-grid part fabrication from FIG. 12:

18. Deposition of 100 um. Pb—Sn solder bumps, removal of photoresit.

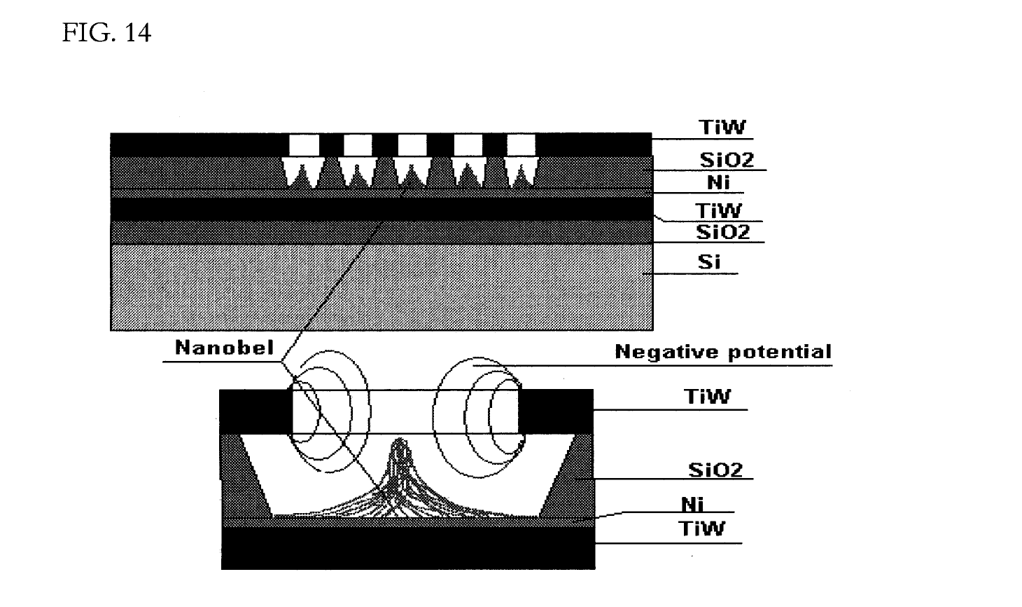

FIG. 14 illustrates the expended view of FIG. 10 for electrochemical deposition of nickel on titan-tungsten film, photolithography of Ni—TiW film, deposition of silicon oxide, photolithography of Via3, deposition of second TiW film, photolithography of TiW for modulation grid MG, etching the silicon oxide films and opening of cathode windows throw first Ni—TiW film, chemical vapor deposition of carbon nanotubes and field orientation of nanotubes as nanobels using the negative potential of modulating grid during the chemical vapor deposition of carbon.

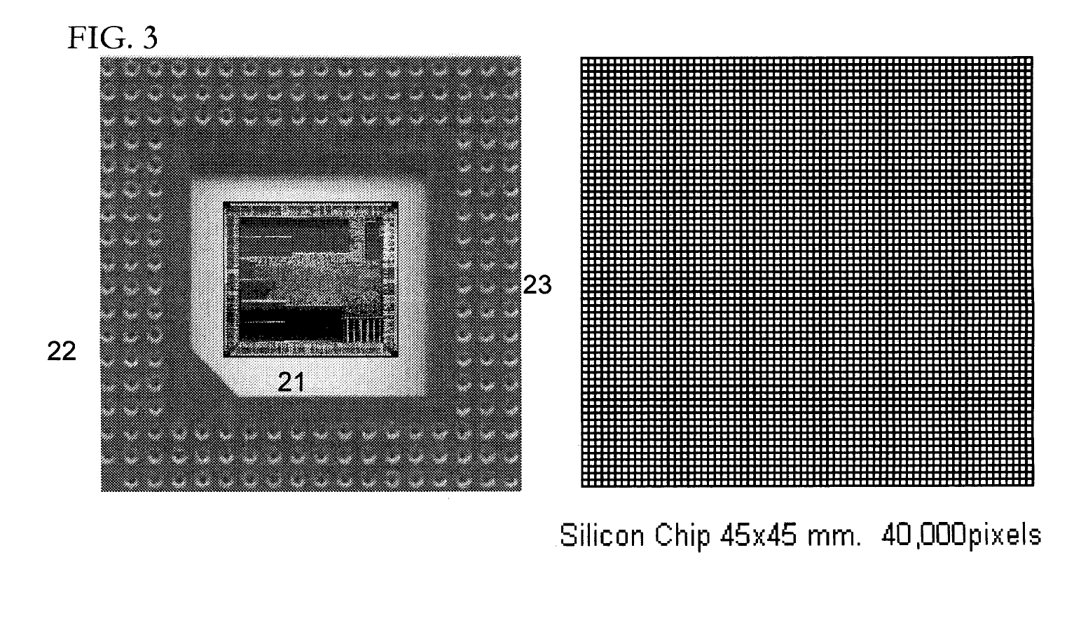

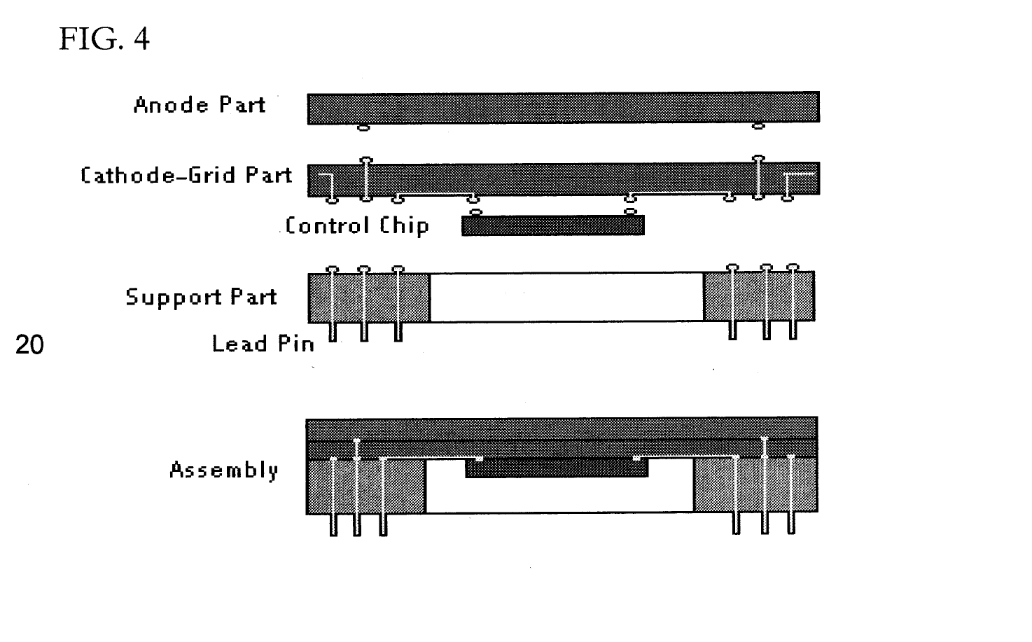

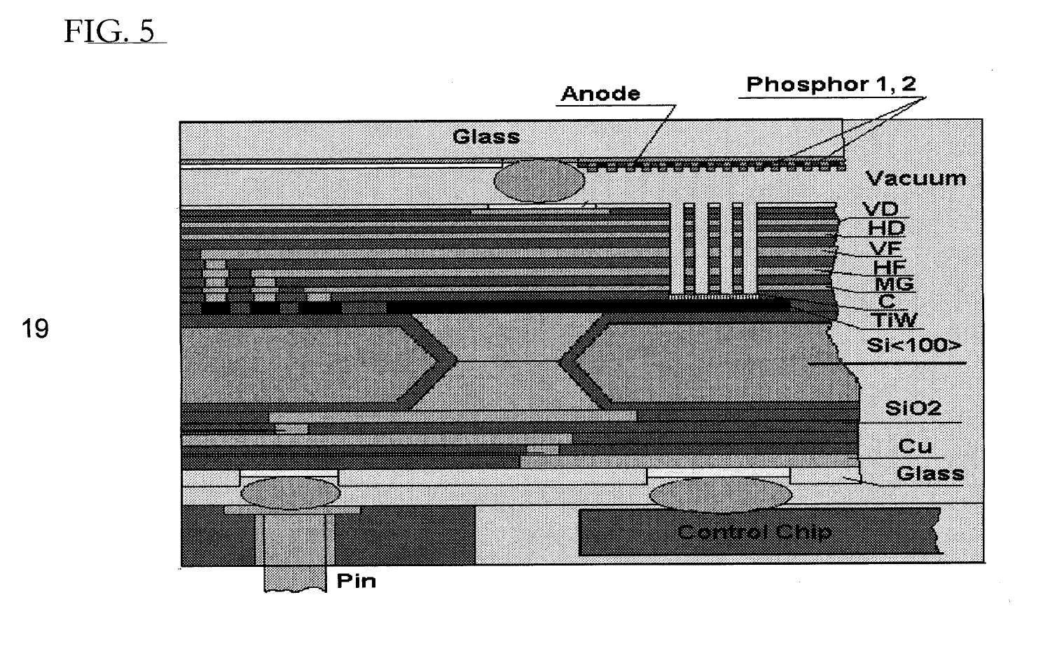

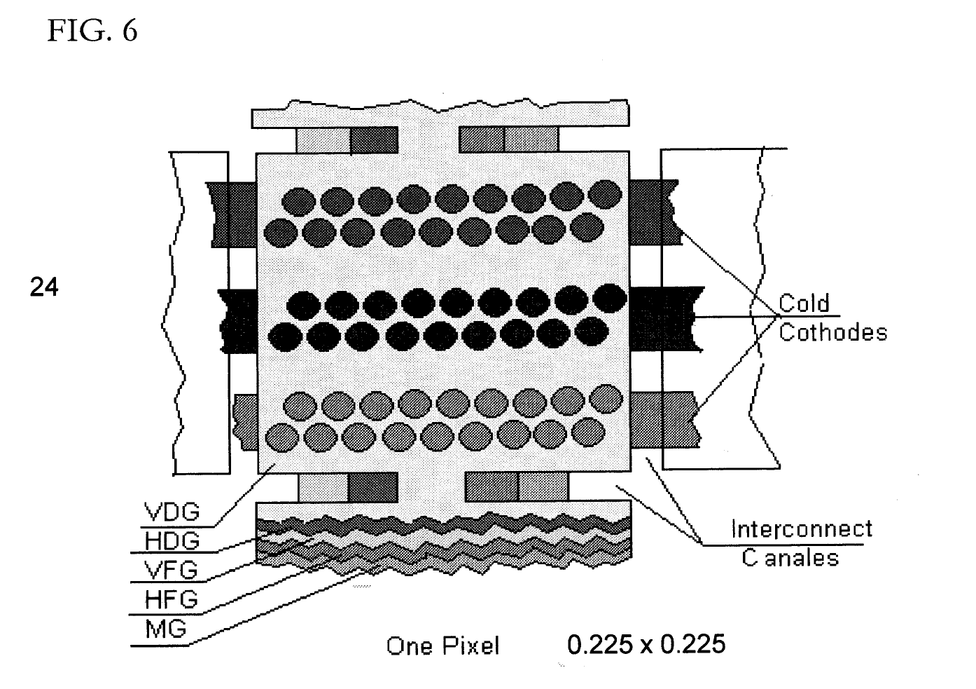

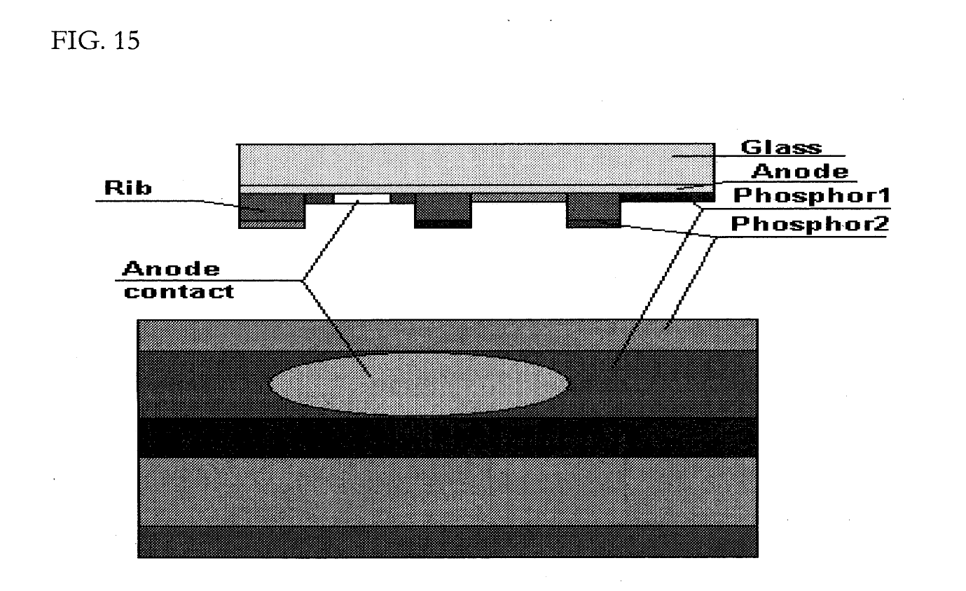

FIG. 15 illustrates the expended view of anode part from FIG. 3. The anode part contain a two level anode structure created by forming a rib with phosphor printed on the top and alternate phosphor colors on the base plate. The spacing between the colors is horizontally zero since electrical isolation is achieved vertically. The width of top phosphor pattern plate is 100 um, the width of the phosphor pattern base plate is 200 um. The interconnect from top surface of cupper on cathode-grid part and anode is performed by etching of phosphor base plate throw anode metal. The anode interconnect place is surrounded by rib.

According to the above-described FED of the present invention, electron beams can be easily focused by the multi-focusing grids, and high luminance can be realized at low current due to electron beam amplification of the individual control chip.

What is claimed is:

1. A flat color display device with carbon thin-film cold cathode field emission is provided for display of information by response to an electron beam of a phosphor coating on a face plate, having a monolithic display sections assembled on multilayer printed wiring board as active matrix, wherein is not restriction for maximum display sections number in the horizontal and vertical directions.

2. The combination set forth in claim 1 in which the monolithic display section is build as ball grid array system on a package and is assembled from four separate fabricated parts: bottom support part, control chip, cathode-grid silicon part and anode top part, wherein the assembled parts are put into a vacuum tight envelope housing the display device as a monolithic section.

3. The combination set forth in claim 2 in which the interconnect between bottom plate, control chip, cathodes, modulating grid, x-y focusing grids, x-y deflecting grids and anode are implemented throw anisotropic etched and insulated holes in silicon cathode-grid part and interlayer vias on both sides of silicon wafer.

4. The combination set forth in claim 2 in which the cathode-grid silicon part includes on one side the multilayer interconnect ball grid array system for surface mount of control chip and bottom support plate using flip-chip bonding technology, wherein on another side of cathode-grid part are implemented the carbon thin-film cold cathode matrix, modulation grid matrix, x-y focusing grid matrix, x-y deflection matrix and top interconnect ball grid array system for surface mount of anode top part using flip-chip bonding technology to.

5. The combination set forth in claim 3 in which interconnect between top side and back side of the silicon cathode-grid part is implemented by performing of metal plugs throw anisotropic etched and insulated holes in silicon wafer.

6. The combination set forth in claim 5 in which the metal plugs are implemented by electrochemical deposition of copper throw anisotropic etched and insulated holes in silicon wafer using the copper plate as cathode connected to silicon wafer, wherein after then the plugs are groused the copper plate is etched.

7. The combination set forth in claim 4 in which the patterned thin film cathode matrix is compose from Titanium-Tungsten film, nickel catalytic film and carbon nanotubes in situ on selective places.

8. The combination set forth in claim 7 in which the carbon nanotubes in situ on selective places are growth and oriented as nanobels using the negative potential of modulating grid during the chemical vapor deposition of carbon.
